(19) United States
(12) Patent Application Publication
(10) Pub. No.: US 2008/0171622 A1
(43) Pub. Date: Jul. 17, 2008

(54) Flatband torsion spring and tensioner

(76) Inventor: Holger Schever, Aachen (DE)

Correspondence Address: THE GATES CORPORATION, IP LAW DEPT. 10-A3, 1551 WEWATTA STREET, DENVER, CO, 80202, US

(21) Appl. No.: 11/653,675

(22) Filed: Jan. 16, 2007

(51) Int. Cl. F16H 7/12; F16F 1/06

(52) U.S. Cl. 474/135; 267/155

(57) ABSTRACT

A tensioner comprising a base (20), a pivot arm (30), a pulley (90) journalled to the pivot arm, a torsion spring (10) engaged between the base and the pivot arm, the torsion spring biasing the pivot arm, the torsion spring comprising a cross-sectional form having a major axis (Z-Z) and a minor axis (X-X), the major axis having a length (h) greater than a minor axis length (b), the torsion spring comprising planar portions (15,16) which are substantially parallel with the major axis, and the major axis oriented in a direction that extends substantially radially and normally from a torsion spring winding axis (Y-Y).

### FIELD OF THE INVENTION

The invention relates to a flatband torsion spring and tensioner wherein a major axis of the flatband spring extends radially and normally from a flatband torsion spring winding axis.

### BACKGROUND OF THE INVENTION

Tensioners are used to apply a preload to a belt drive system. A preload assures proper non-slip engagement of the belt with a driving pulley and various driven pulleys.

Use of round wire for tensioner springs is well known. Also known are spring made of flatband wires comprising of straight bar with rectangular cross section wherein a major axis of the flatband cross section is parallel to the winding axis of the spring. Such flatband springs require a reduced volume for a given torque when compared to a round wire spring or equal torque capacity.

Representative of the art is U.S. Pat. No. 5,496,221 (1996) to Gardner which discloses a belt tensioning system, a belt tensioner therefore and methods of making the same are provided, the belt tensioning system comprising a tensioner arm pivotally mounted to a support, and a wound coiled spring having opposed ends one of which is operatively interconnected to an abutment of the support and the other of which is operatively interconnected to the arm, the arm having a shoulder for being engaged by the one of the opposed ends of the wound coiled spring so as to permit removal of the arm and the wound coiled spring as a self-contained unit from the support when the arm is pivoted to a certain position where the shoulder of the arm engages the one end of the spring and effectively moves the one end of the wound coiled spring out of contact with the abutment of the support.

What is needed is a flatband torsion spring and tensioner wherein a major axis of the flatband spring extends radially and normally from a flatband torsion spring winding axis. The present invention meets this need.

### SUMMARY OF THE INVENTION

The primary aspect of the invention is to provide a flatband torsion spring and tensioner wherein a major axis of the flatband spring extends radially and normally from a flatband torsion spring winding axis.

Other aspects of the invention will be pointed out or made obvious by the following description of the invention and the accompanying drawings.

The invention comprises a tensioner comprising a base (20), a pivot arm (30), a pulley (90) journalled to the pivot arm, a torsion spring (10) engaged between the base and the pivot arm, the torsion spring biasing the pivot arm, the torsion spring comprising a cross-sectional form having a major axis (Z-Z) and a minor axis (X-X), the major axis having a length (h) greater than a minor axis length (b), the torsion spring comprising planar portions (15,16) which are substantially parallel with the major axis, and the major axis oriented in a direction that extends substantially radially and normally from a torsion spring winding axis (Y-Y).

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the inventive spring.

FIG. 2 is a cross sectional view of the inventive spring at 2-2 in FIG. 1.

FIG. 3 is an exploded view of a tensioner using the inventive spring.

### DETAILED DESCRIPTION OF THE PREFERRED EMBODIMENT

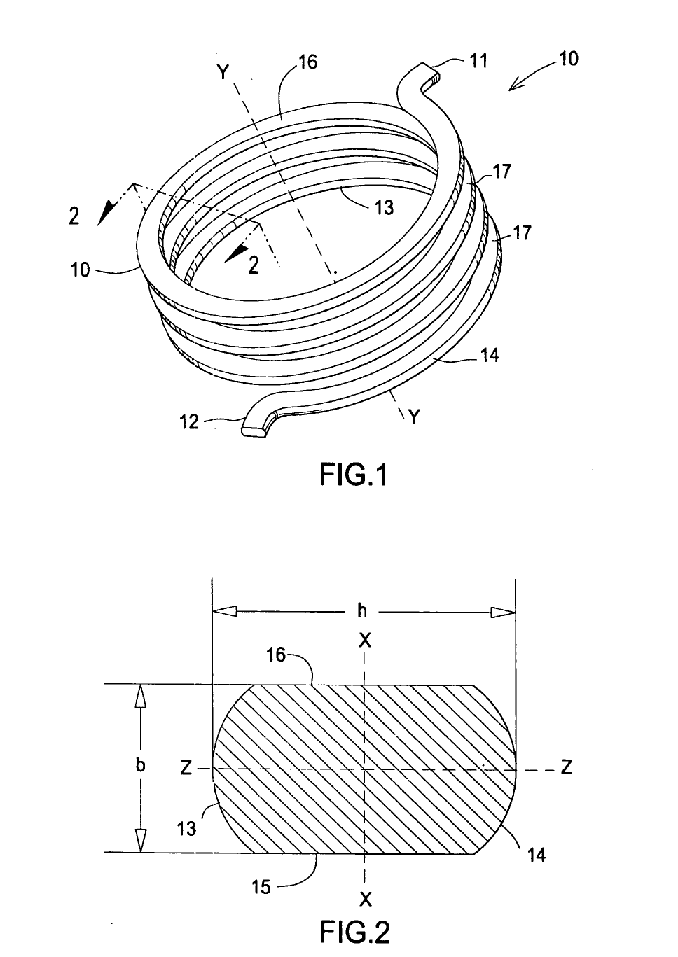

FIG. 1 is a perspective view of the inventive spring. Spring 10 is a torsion spring having a plurality of coils 17. Each end 11, 12 allows engagement of the spring with suitable mounting portions. The winding axis of spring 10 is Y-Y.

FIG. 2 is a cross sectional view of the inventive spring at 2-2 in FIG. 1. Spring 10 comprises arcuate sides 13, 14 disposed on each side of substantially flat planar portions 15, 16. The convex arcuate sides 13, 14 are formed during production of the wire wherein round wire is rolled to the desired flat shape. A major axis Z-Z extends radially and normally with respect to winding axis Y-Y. The major axis Z-Z has a length greater than a minor axis X-X. The planar portions 15, 16 are substantially parallel to major axis Z-Z.

Spring 10 may comprise any resilient material, including spring steel or plastic depending upon the service conditions.

The equations governing a coil spring made of round wire and a coil spring made of flatband wire are the same with the exception of the following. The wire section inertia for round wire is set forth in equation I_{round}. The wire section inertia for flatband wire is set forth in equation I_{flatband}.

$$\begin{matrix}{I}_{round} \frac{π \cdot {d}^{4}}{64} \\ {I}_{Flatband} = \frac{b \cdot {h}^{3}}{12}\end{matrix}$$

Where “d” is the diameter of the wire and “b” and “h” are the dimensions shown in FIG. 2.

The advantage of a flatband spring compared to a round wire spring with the same wire section inertia and same number of coils, same deflection angle and same wire stress is, that the effective maximum compressed spring height is less for the flatband spring. This allows the flatband spring to apply higher torques in the same housing conditions. With a given desired torque and fixed axial spring housing height or envelope, depending on the application using a flatband spring the desired torque can be reached where the round wire spring will not fit in the housing and envelope.

Following is a sample calculation for the purpose of illustrating the desirable features of the inventive spring.

### Round Spring Calculation

$$T = \frac{{d}^{4} \cdot E \cdot α}{3667 \cdot {D}_{m} \cdot n}$$

$$σ = \frac{32}{π \cdot {d}^{3}} \cdot T$$

Flatband spring dimensions:

$${I}_{Round} = {I}_{Flatband}$$

$$\frac{π \cdot {d}^{14}}{64} = \frac{b \cdot {h}^{3}}{12}$$

$$d = \sqrt{\frac{16}{3} \cdot \frac{b * {h}^{3}}{π}}$$

Now “b” and “h” can be chosen so that “d” becomes equal in each case for the calculated torque and stress. Dimension “b” is chosen to be less than “h” in order to realize the packaging advantage of a flatband spring compared to a round wire spring.
Spring height, or axial length with respect to axis Y-Y. The maximum round spring heights (diameter) are calculated as:

$${H}_{{spring}_{Round}} = d \cdot ( n + \frac{{α}_{max}}{360 °} ) + d$$

$${H}_{{spring}_{Flatd}} = b \cdot ( n + \frac{{α}_{max}}{360 °} ) + b$$

### With

$${I}_{round} = \frac{π \cdot {d}^{4}}{64}$$

$${I}_{Flatband} = \frac{b \cdot {h}^{3}}{12}$$

follows

$${I}_{Round} = {I}_{Flatband}$$

$$\frac{π \cdot {d}^{4}}{64} = \frac{b \cdot {h}^{3}}{12}$$

This leads with b<h to b<d
Hₛₚᵣᵢₙ_{_{Flat}}<H_{spring}_{_{Round}}

### Variables and Symbols:

### T Spring Torque

d Round wire diameter
E Elastic modulus
α Deflection angle
Dm Mean coil diameter
n Number of coils
σ Wire stress
l Wire inertia
b Flatband wire width
h Flatband wire height
H_{spring}_{_{Round}} Round wire spring height
Hₛₚᵣᵢₙ_{_{Flat}} Flatband wire spring height

Following is an example calculation using numeric values for the noted variables and is intended to illustrate the invention without limiting the scope of the claims or its application.

| | Round | Flatband |
|---|---|---|
| | Wire | Wire |
| Max. available housing height [mm] | 9 | 9 |
| Round wire diamter [mm] | 3.23 | — |
| Flatband height [mm] | — | 3.5 |
| Flatband width [mm] | — | 1.5 |
| Number of coils | 2.9 | 2.9 |
| Mean coil diameter [mm] | 42 | 42 |
| Wire inertia [mm⁴] | 5.13 | 5.13 |
| Nominal deflection [°] | 80 | 80 |
| Max. deflection [°] | 102 | 102 |
| Torque at nominal deflection [Ncm] | 387 | 387 |
| Max. spring height at max. deflection [mm] | 9.64 | 6.18 |

Given equivalent torques at nominal deflection, 387 Ncm, the maximum spring height of the inventive spring is only 6.18 mm as compared to 9.64 mm for a round wire spring. This represents an axial height reduction (axis Y-Y, FIG. 1) of approximately 35%. This significant reduction allows a requisite torque output to be available in a thinner tensioner package. This allows use of a tensioner in a smaller operational volume, or, allows a greater torque to be realized in a given operational volume where it is not possible to increase the size of the tensioner to accommodate a greater torque requirement.

This also illustrates an aspect ratio for the dimension “h” to dimension “b” (h:b) of approximately 2.3. The inventive spring may be manufactured with an aspect ratio greater than 1 with equal success.

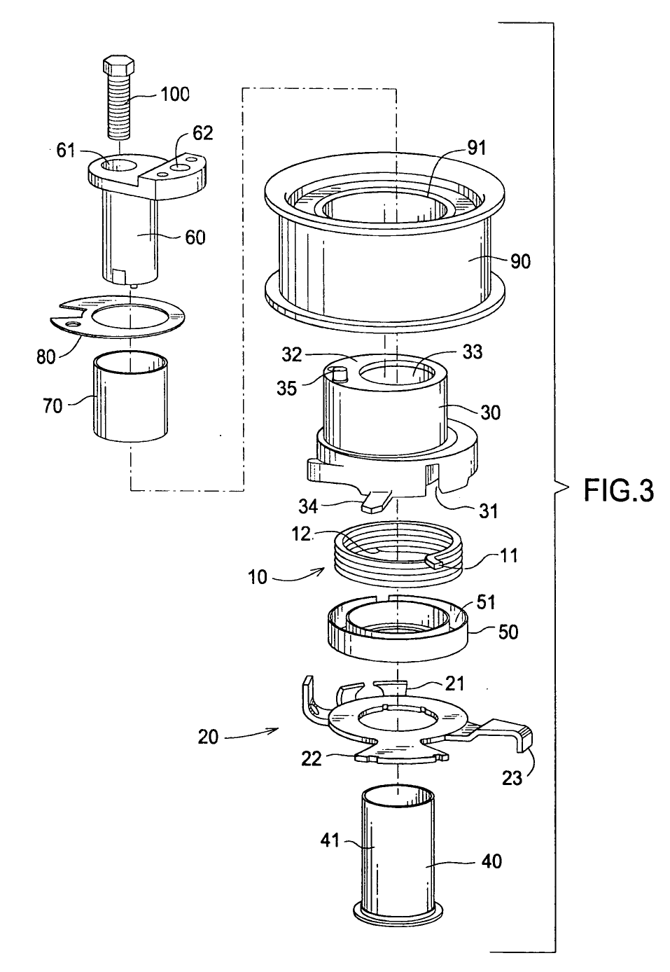

FIG. 3 is an exploded view of a tensioner using the inventive spring. The example eccentric tensioner described herein is only for the purpose of illustration and not by way of limiting the breadth or applicability of the inventive spring.

The eccentric tensioner comprises a base 10. Sleeve 40 projects through base 10. Arm 30 is pivotally engaged on sleeve 40 through bushing 70. Bushing 70 and sleeve 40 may comprise any suitable low friction material including plastic. The plastic may be oil impregnated or have a coating of PTFE. A damping pad 50 engages spring 10. Spring 10 rests within damping pad 50 in a channel 51. Damping pad 50 helps to damp undesirable oscillations of arm 30 during operation by a rubbing engagement with base 20 and arm 30.

An end 11 of spring 10 engages slot 31 in arm 30. An end 12 of spring 10 engages a member 21 of base 20. In operation spring 10 biases arm 30 against base 20 to apply a spring torque through bearing 91 and pulley 90 to load a belt (not shown). Base 20 is prevented from rotating by engagement of member 23 with a receiving portion of a mounting surface (not shown).

Adjuster 60 engages arm 30 through bore 33. The adjuster is used to eccentrically locate the center of rotation of arm 30 in order to properly orient the belt load with respect to the range of movement of arm 30. The arm 30 position is adjusted during installation of the tensioner by inserting a tool (not shown) in tool receiving portion 62.

A fastener 100 is used to attach the tensioner to a mounting surface (not shown) such as an engine block. Fastener 100 extends through a bore 61 in adjuster 60.

Proper adjustment of the tensioner is accomplished using indicator 34 on arm 30 and indicator 22 on base 20. The arm is rotated until indicator 34 aligns with the corresponding portion of indicator 22. The arm and base are then pinned together using pin 35.

Once the tensioner is installed in the operational location, and indicators 34,22 are properly aligned, fastener 100 is torqued down, which also prevents movement of adjuster 60. Bushing 70 on sleeve allows arm 30 to move freely about sleeve 40.

Seal 80 engages a top surface 32 of arm 30 to prevent intrusion of debris between the arm bore 33 and sleeve 40 and thereby into the bearing surface 41 of sleeve 40. Debris would adversely affect operation of the tensioner. A belt (not shown) engages pulley 90. Pulley 90 is journalled through bearing 91 to arm 30.

Although a form of the invention has been described herein, it will be obvious to those skilled in the art that variations may be made in the construction and relation of parts without departing from the spirit and scope of the invention described herein.

We claim:

1. A tensioner comprising:
a base (20);
a pivot arm (30);
a pulley (90) journalled to the pivot arm;
a torsion spring (10) engaged between the base and the pivot arm, the torsion spring biasing the pivot arm;
the torsion spring comprising a cross-sectional form having a major axis (Z-Z) and a minor axis (X-X), the major axis having a length (h) greater than a minor axis length (b);
the torsion spring comprising planar portions (15,16) which are substantially parallel with the major axis; and
the major axis oriented in a direction that extends substantially radially and normally from a torsion spring winding axis (Y-Y).

2. The tensioner as in claim 1 further comprising convex arcuate sides (13,14) disposed between the planar portions.

3. The tensioner as in claim 1 further comprising an adjuster engaged with the arm, the adjuster having a tool receiving portion whereby an arm position is adjusted.

4. A torsion spring comprising:
a coil of resilient material having a winding axis (Y-Y);
the coil having a cross-sectional form comprising a major axis (Z-Z) and a minor axis (X-X), the major axis having a length (h) greater than a minor axis length (b);
the coil comprising substantially planar portions (15,16) that are disposed opposite each other between arcuate sides (13,14), and which planar portions are substantially parallel with the major axis; and
the major axis oriented in a direction that extends substantially radially and normally from a torsion spring winding axis (Y-Y).

5. The torsion spring as in claim 4, wherein the aspect ratio for the dimension (h) to dimension (b) (h:b) is greater than 1.
